(19) United States
(12) Patent Application Publication
(10) Pub. No.: US 2026/0214307 A1
(43) Pub. Date: Jul. 23, 2026

(54) Media Container File Format for Depth, Editing, and Machine Learning

(71) Applicant: Google LLC, Mountain View, CA (US)

(72) Inventors: Fares Alhassen, Redwood City, CA (US); Jana Ehmann, San Francisco, CA (US); Fedir Kyslov, Pflugerville, TX (US); Andrew Benedict Lewis, London (GB); Sonya Avi Mollinger, Mountain View, CA (US)

(21) Appl. No.: 19/140,894

(22) PCT Filed: Dec. 18, 2023
(86) PCT No.: PCT/US2023/084560

§ 371 Date: Jun. 18, 2025

Related U.S. Application Data
(60) Provisional application No. 63/476,105, filed on Dec. 19, 2022.

(51) Int. Cl. H04N 21/854; G11B 27/031; H04N 21/81

(52) U.S. Cl. CPC H04N 21/85406; G11B 27/031; H04N 21/816

(57) ABSTRACT

A video capture device and method for implementing a media, container are disclosed. An example method includes receiving a first video track in a first file format, wherein the first video track is compatible with a first group of data devices configured to play the first file format, generating at least one supplementary track in the first file format and supplementary' track metadata, wherein the at least one supplementary track is associated with the first video track, and generating a media container including the first video track and a nested container, wherein the nested container includes at least one supplementary track and the supplementary track metadata, and wherein the nested container is accessible to a second group of data devices configured to play one of the at least one supplementary' tracks according to the supplementary—track metadata.

### CROSS-REFERENCE TO RELATED APPLICATION

This application claims priority to U.S. Provisional Application No. 63/476,105, filed Dec. 19, 2022, which is incorporated herein by reference in its entirety.

### BACKGROUND

Many modem computing devices, including mobile phones, personal computers, and tablets, are configured to operate as video capture devices. Such video capture devices may possess different capabilities for editing and processing captured images and videos. For example, some video capture devices may provide a video track compatible with a first group of legacy data devices. In other examples, one or more video capture devices may provide a video track that includes edits and special effects applied by the video capture device compatible with another group of data devices having a different set of capabilities relative to the first group. Providing a file format accessible between devices while supporting the capabilities of each group is desirable. Solutions attempting to address these requirements may not provide adequate backwards compatibility while supporting new capabilities and editing applications.

### SUMMARY

Example devices and methods described herein may provide a backward compatible media container configured to support video capture devices of varying editing and playback capabilities of the resulting videos and images. For example, the media container allows for the creation and storage of video tracks including edits processed and applied by the video capture device. Additionally, the media container allows for post-capture, editing by one or more editing applications. One example of a media container may include a primary video track configured for compatibility with existing media players and data devices. The example media container may further include one or more tracks that may be utilized for high fidelity rendering, editing operations, and/or as machine learning data.

In some examples, a method includes receiving a first video track in a first file format, wherein the first video track is compatible with a first group of data devices configured to play the first file format, and generating at least one supplementary track in the first file format and supplementary track metadata, wherein the the at least one supplementary track is associated with the first video track. The method further includes generating a media container including the first video track and a nested container, wherein the nested container includes the at least one supplementary track and the supplementary track metadata, and wherein the nested container is accessible to a second group of data devices configured to play one of the at least one supplementary tracks according to the supplementary track metadata.

In some examples, a video capturing device includes one or more processors and one or more non-transitory computer readable media storing program instructions executable by the one or more processors to perform operations. The example video capture device performs the operations of receiving a first video track in a first file format, wherein the first video track is compatible with a first group of data devices configured to play the first file format, and generating at least one supplementary track in the first file format and supplementary track metadata, wherein the at least one supplementary track is associated with the first video track. The example video capture device further performs the operations of generating a media container including the first video track and a nested container, wherein the nested container includes the at least one supplementary track and the supplementary track metadata, and wherein the nested container is accessible to a second group of data devices configured to play one of the at least one supplementary tracks according to the supplementary track metadata.

In some examples, one or more non-transitory computer readable media are provided storing program instructions executable by one or more processors to perform operations. The example operations include receiving a first video track in a first file format, wherein the first video track is compatible with a first group of data devices configured to play the first file format, and generating at least one supplementary track in the first file format and supplementary track metadata, wherein the at least one supplementary track is associated with the first video track. The example operations further include generating a media container including the first video track and a nested container, wherein the nested container includes the at least one supplementary track and the supplementary track metadata, and wherein the nested container is accessible to a second group of data devices configured to play one of the at least one supplementary tracks according to the supplementary track metadata.

In another example, means are provided for performing operations including receiving a first video track in a first file format, wherein the first video track is compatible with a first group of data devices configured to play the first file format, and generating at least one supplementary track in the first file format and supplementary track metadata, wherein the at least one supplementary track is associated with the first video track. The operations further include generating a media container including the first video track and a nested container, wherein the nested container includes the at least one supplementary track and the supplementary track metadata, and wherein the nested container is accessible to a second group of data devices configured to play one of the at least one supplementary tracks according to the supplementary track metadata.

The foregoing summary is illustrative only and is not intended to be in any way limiting. In addition to the illustrative aspects, examples, and features described above, further aspects, examples, and features will become apparent by reference to the figures and the following detailed description and the accompanying drawings.

### BRIEF DESCRIPTION OF THE FIGURES

FIG. 1 illustrates an example computing device.

FIG. 2 illustrates a simplified block diagram showing some of the components of an example computing system.

FIG. 3 is a diagram illustrating a training phase and an inference phase of one or more trained machine learning models in accordance with example embodiments.

FIG. 4 is a block diagram of an example multimedia container in accordance with example embodiments.

FIG. 5 is a flowchart of an example method for implementing a media container file format in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first.” “second,” “third” and so on is to distinguish respective elements rather than to denote a particular order of those elements. For the purpose of this description, the terms “multiple” and “a plurality of” refer to “two or more” or “more than one.” Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

Digital cameras, smartphones and tablet computers are all types of video capture devices that often include one or more imaging devices such as a charged-coupled device (CCD). Video capture devices including one or more imaging devices are often configured to capture video data according to one or more video file formats. For example, video file formats such as the Matroska file format (mkv), the MPEG transport stream (MTS), and the MPEG-4 (mp4) file format are examples of a digital multimedia container format utilized to store and organize video data, audio data, and other data such as subtitles and still images. These video file formats are compatible with a wide array of data devices and replay devices but may not support all the functionality and capabilities offered by one or more video capture devices.

In order to support additional capabilities while maintaining backward compatibility, a digital multimedia container or media container may incorporate the existing MPEG-4 (mp4) file format while providing a mechanism to organize, store, and access additional information necessary to support the functionality and capabilities offered by one or more video capture devices. In some examples, a media container is configured to include a primary video track configured for compatibility with existing media players and data devices and one or more supplementary tracks that may be utilized for high fidelity rendering, editing operations, and/or as machine learning data. For example, the primary video track of the media container may store video data in the MPEG-4 (mp4) file format or other ISO base media file format (ISOBMFF). The primary video track is configured for backwards compatibility to the wide array of data devices and replay devices that do not support the additional functionality and capabilities.

The media container may further be configured to include a media box or other data storage element. The media box may be a nested container defined within the media container. The media box may specify an offset and a length with respect to the media container. Examples of the media box include an enhanced descriptor for visual and depth data (edvd) box or other data storage elements defined according to ISO/IEC 14496-12 standards. The payload of the edvd box may be another video data file in the MPEG-4 (mp4) format identified as a source track. The source track may further include the information and supplementary tracks to generate a composite video track. In some examples, the source track may specify a version, a track count, and a track type. The track types may include a sharp type, a linear depth type, an inverse depth type, metadata, and a translucent type.

### II. Example Systems and Methods

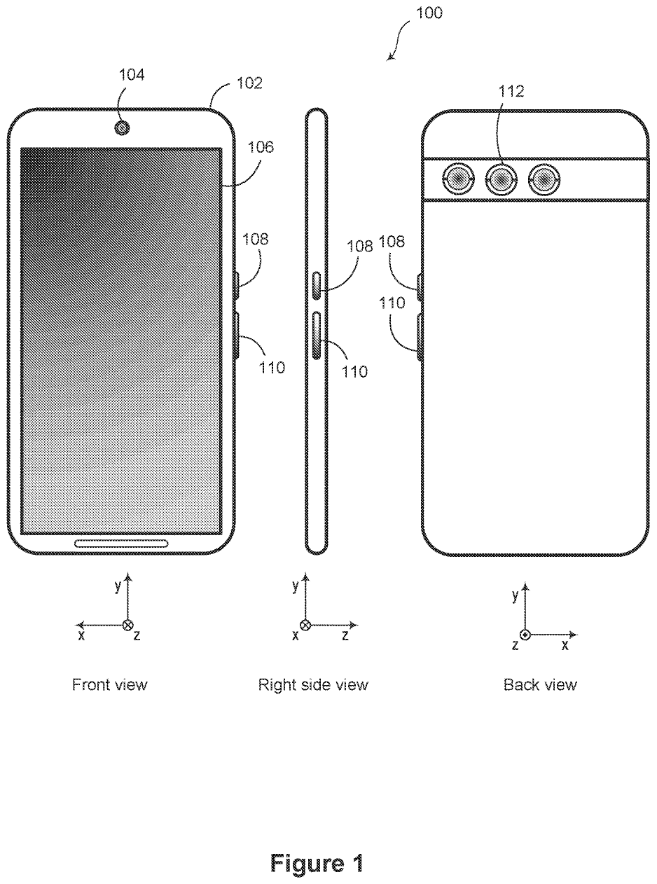

FIG. 1 illustrates an example computing device 100. In examples described herein, computing device 100 may be a video capturing device. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. Each of the cameras may include a charged-coupled device (CCD) or other imaging device. The wide angle camera may capture a larger portion of the environment compared to the main camera and the telephoto camera, and the telephoto camera may capture more detailed images of a smaller portion of the environment compared to the main camera and the wide angle camera. In this way, each CCD or imaging device may be optimized for different focal lengths, physical conditions, or for other desirable characteristics.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a single still image, a plurality of still images, or a stream of video data. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

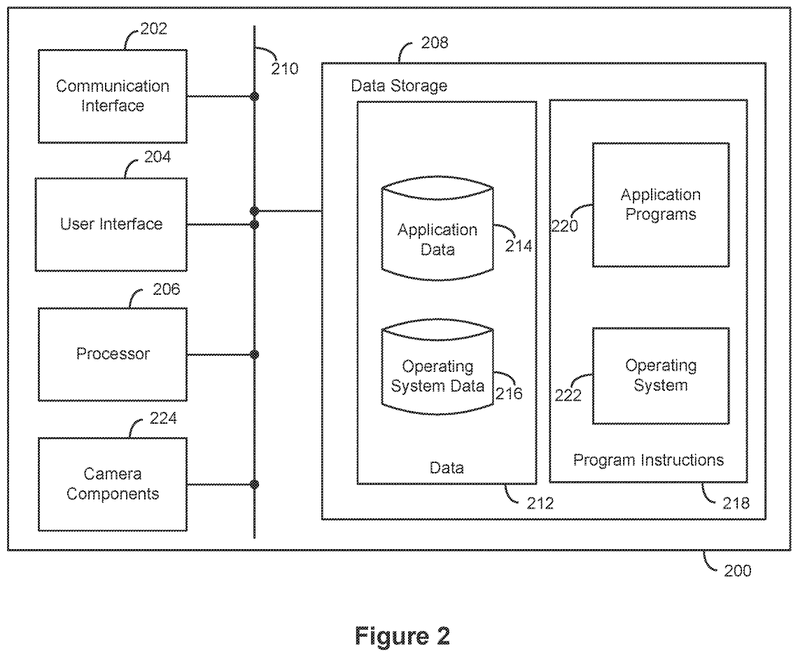

FIG. 2 is a simplified block diagram showing some of the components of an example computing system 200, such as a video capturing device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s). via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors e.g., microprocessors-and/or one or more special purpose processors-e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include an imaging sensor such as a charge-coupled device (CCD). Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

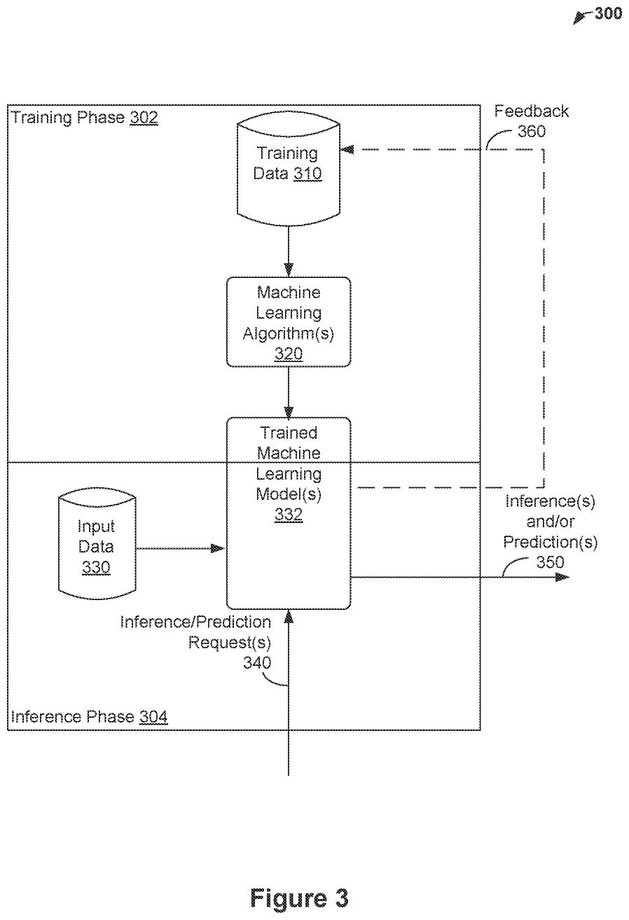

FIG. 3 shows diagram 300 illustrating a training phase 302 and an inference phase 304 of trained machine leaming model(s) 332, in accordance with example embodiments. Some machine leaming techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 3 shows training phase 302 where one or more machine learning algorithms 320 are being trained on training data 310 to become trained machine learning model 332. Producing trained machine learning model(s) 332 during training phase 302 may involve determining one or more hyperparameters, such as one or more stride values for one or more layers of a machine learning model as described herein. Then, during inference phase 304, trained machine learning model 332 can receive input data 330 and one or more inference/prediction requests 340 (perhaps as part of input data 330) and responsively provide as an output one or more inferences and/or predictions 350. The one or more inferences and/or predictions 350 may be based in part on one or more learned hyperparameters, such as one or more leamed stride values for one or more layers of a machine learning model as described herein As such, trained machine learning model(s) 332 can include one or more models of one or more machine learning algorithms 320. Machine learning algorithm(s) 320 may include, but are not limited to: an artificial neural network (e.g., a hercin-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 120 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or reinforcement learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct results for part, but not all, of training data 310. During semi-supervised learning, supervised learning is used for a portion of training data 310 having correct results, and unsupervised learning is used for a portion of training data 310 not having correct results.

Reinforcement learning involves machine learning algorithm(s) 320 receiving a reward signal regarding a prior inference, where the reward signal can be a numerical value. During reinforcement learning, machine learning algorithm(s) 320 can output an inference and receive a reward signal in response, where machine learning algorithm(s) 320 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to computing device CD1, where CD1 is intended to execute the trained machine learning model during inference phase 304. Then, during training phase 302, the pre-trained machine learning model can be additionally trained using training data 310. This further training of the machine learning algorithm(s) 320 and/or the pre-trained machine learning model using training data 310 of CDI's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to computing device CD1.

During inference phase 304, trained machine learning model(s) 332 can receive input data 330 and generate and output one or more corresponding inferences and/or predictions 350 about input data 330. As such, input data 330 can be used as an input to trained machine learning model(s) 332 for providing corresponding inference(s) and/or prediction(s) 350. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from computing device CD1 executing trained machine learning model(s) 332 and/or input data from one or more computing devices other than CD1.

### III. Example Format for a Media Container

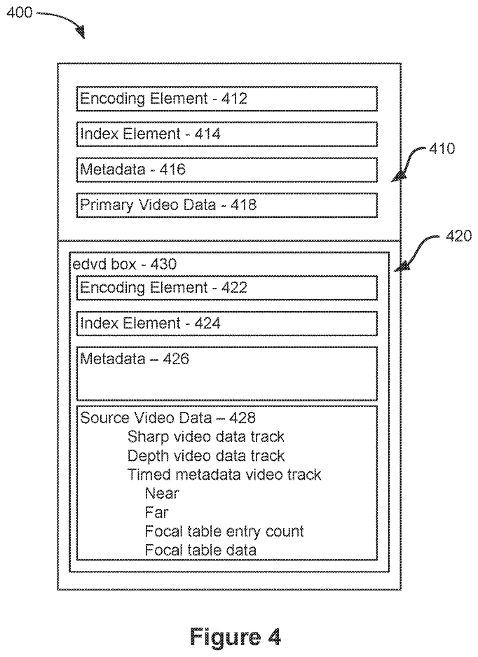

FIG. 4 illustrates an example of a media container 400 that may be generated as an output of the camera components 224 operating in conjunction with one or more application programs 220. The media container 400 may include a primary track 410 and a source track 420. The primary track 410 may be configured in MPEG-4 (mp4) file format. For example, the primary track 410 may be configured with one or more video tracks and one or more audio and/or data tracks compatible with most video capture and replay devices. In one example, the primary track 410 may include an encoding element 412, an index element 414, metadata 416, and a primary video data 418.

The encoding element 412 may specify a four letter ftyp code that can be used to identify the type of encoding used as part of the primary track 410, the compatibility and/or intended use of the primary track 410. The index element 414 may include an MPEG-4 “moov boxes” configured to store information about the primary track 410 to enable one or more replay devices to play and access the video data contained within the primary track 410. The index element 414 may further include information specifying video resolution, frame rates, orientation, display characteristics, and other information to facilitate access by the one or more replay devices. The index element 414 may be needed for a replay device to access the information, including video data, contained within the primary track 410. The primary track 410 may further include metadata 416 related to the format standard. The primary video data 418 or movie data may be encoded and stored according to H.264/AVC, H.265/HEVC, VP9, AV1 or other codecs.

The information included as part of the primary track 410 is supported by video capture devices and replay devices that support both limited and advanced editing and capture functionality.

The source track 420 may be stored within an enhanced descriptor for visual and depth data (edvd) box 430 such as a box defined according to ISO/IEC 14496-12:2015:4.2 standards. The edvd box 430 may be detected and read by video capture devices and replay devices that support advanced editing and capture functionality. The source track 420 stored within the edvd box 430 may be configured according to the MPEG-4 (mp4) format. Accordingly, the source track 420-similar to the primary track 410-includes an encoding element 422, an index element 424, metadata 416, and a source video data 428.

In some examples, the encoding element 422 specifies a four letter ftyp code used to identify the type of encoding implemented as part of the source track 420, the compatibility and/or intended use of the source track 420. The index element 424 may be an MPEG-4 “moov boxes” configured to store information about the source track 420 to enable one or more replay devices to play and access the video data contained within the source track 420. The index element 424 may further include information specifying video resolution, frame rates, orientation, display characteristics, and other information to facilitate access by the one or more replay devices. The index element 424 may be needed for a replay device to access the information, including video data, contained within the source track 420. The source track 420 may further include metadata 426 specifying version information, a track count and a track type for each track specified as part of the track count. The source video data 428 may include one or more supplementary tracks used to generate a composite track.

In some examples, the source track 420 including the source video data 428 may further include a first track storing video data having depth metadata, and a second track including a rendered bokeh video track for playback devices. The rendered bokeh video track may be utilized to selectively blur regions of a displayed image or video in order to improve the aesthetic quality. In one example, the edvd box 430 may further include a depth MP4 which has a sharp video track stored at full resolution without editable depth-based effects applied, and a depth map track. In some examples the supplemental video tracks stored as part of the source track 420 may be stored at a different resolution than the primary video track 410. For example, at capture time the video capture device may not include the available resources to render the primary bokeh video track with depth-based effects at full capture resolution. Accordingly, the rendered bokeh video track may be stored at a lower-and less resource intensive-video resolution.

The depth MP4 included as part of the edvd box 430 may further include a timed metadata track as part of the store supplementary tracks. The timed metadata track may include normalizing values associated with a depth and focal table utilized to calculate a blur radius. The timed metadata track may be configured in a binary format that specifies a near distance (16-bit float), a far distance (16-bit float), depth encoding type (range inverse or linear), a focal table entry count (16-bit int), and a focal table entry that includes an entry distance (16-bit float) and an entry radius (16-bit float). The value provided in the binary format may be interpreted based on Dynamic Depth 1.0 specification. In operation, individual timestamps should be synchronized between the timed metadata track, the sharp video track and the depth map track.

In some examples, the depth map track may be encoded as standard grayscale video to allow for decoding and encoding depth tracks on devices that don't have any special decoding/encoding support for depth. It will be understood that the units of the depth 14 data are selected to match the units of the distance values in the timed metadata track and may be encoded using H.264/AVC, H.265/HEVC, VP9, AV1 or other codecs. In some examples, the included sharp video tracks may use HDR video formats (10-bit, 12-bit), while the depth video tracks may be 8-bit, inverse-or linear-encoded. Further encoding information may be stored as part of the metadata 326. In other examples, the depth video tracks may be 16-bit tracks and/or encoded in different manners.

In some examples, segmentation information may be provided for the primary video track 410. The segmentation information can be determined from machine-learning-based techniques or heuristics as part of a translucent track. The translucent track may be encoded as a standard grayscale, 8-bit video. In some examples, the segmentation data may be interpreted according to the use case such that, for example, a threshold of 127 may be used to indicate pixels in the foreground or background. For example, pixels with values less than or equal to 127 may indicate foreground pixels, with values greater than or equal to 128 indicating background pixels. In other examples, multiple pixel thresholds may be established allowing for further segmentation into a set of classes. In some examples, a separate supplemental track corresponding to each class of multiple different classes may involve assigning a probability or confidence to each pixel. For example, a class identifying skin tones may assign a probability or confidence to each pixel, and a class identifying a human may assign another probability or confidence to each pixel. In this way classes may be layered and or overlapped. In some examples, the multiple pixel thresholds established for various segmentation classes may be selected in order to avoid recompression artifacts switching pixels from one class to another. In some examples, lossless encoding may be utilized when segmentation information is associated with the primary video track 410.

In some examples, an example of post-capture depth editing is provided. For example, the primary video track 410 may be a blur-encoded video track (with bokeh included). The supplemental or secondary tracks 420 may include the original video, the depth track, and the timed metadata indicating how an editing app should interpret the depth track. The editing app is software that may decode the secondary tracks 420 and apply the depth maps to the original video frames. The information included in the timed metadata track may be used for “re-focusing” by moving the focal plane in the z-direction of the depth map and adjusting the blur accordingly. In this way, the blur may be positioned to blur or unblur different portions of the video data such as the original video included in the secondary tracks 420. The editing app or software may also modify the depth video track by, for example, decoding the depth video track, processing it in OpenGL to reflect edits such as compositing an augmented reality (AR) model into the original video, and then re-encoding the depth video track. The resulting primary track may, in turn, be regenerated using the reencoded depth track so that the edited primary track is selected for playback by default by video players.

In some examples, the primary video track 410 is a track with arbitrary (e.g. color, spatial, stickers) edits applied. Additional tracks provide the unedited track and a timed metadata track that specifies the edit representation per frame. An editing software or app can decode the metadata track and the unedited track to render the existing edits on top of the unedited frames and allow removal of individual edits or addition of further edits (i.e. “re-editing”).

In some examples, the primary video track 410 is a track with edits applied to the background (e.g. “green screen”).

In some examples, additional tracks provide the unedited track and the alpha track that identifies foreground vs background pixels. An editing software or app can apply a different background over the unedited track by matching against the alpha track.

In some examples, additional tracks provide the depth map per frame and the timed metadata. Editing software and apps can further apply the depth per frame to original tracks to play back a blurred version of the video.

In some examples, additional tracks provide the alpha map (foreground/background segmentation) per frame. Editing software and apps can further add background replacements by combining the original and alpha tracks.

In some examples, additional tracks provide segmentation information per frame marking detected faces or other objects of interest. Editing software and apps can modify pixels relating to these objects by combining the original track, segmentation track, and other supplementary tracks.

In some examples, additional tracks provide multiple camera views for use in compositing an augmented reality (AR) model, for example for refocusing the perspective of the video.

In some examples, additional tracks provide the depth map which can be used when adding AR models into the scene in an editing operation. The depth map provides enough information to occlude the AR model when it passes behind objects in the scene, and the depth map can be updated when re-exporting the video to reflect the new objects in the scene closer to the viewer.

In some examples, additional tracks in the source mp4 provide arbitrary timed metadata that can be used and combined with the source video to derive a new primary/derived track.

In some examples, the primary video track 410 may be the original (unedited track) for use cases that don't want to play a derived (e.g. blurred) video, but still want post-capture editing abilities. The supplemental or secondary video tracks 420 provide the information for software to edit or play back in real time with edits applied.

In some examples, applications may remove the edvd box 430 entirely and write a new file solely with the primary video track 410 and other tracks in a top-level ISOBMFF container. For example, a user may be satisfied with the primary video track 410 and would prefer to save space.

In some examples, applications may keep the edvd box 430 when sharing to keep interoperability.

### IV. Example Methods of Operation

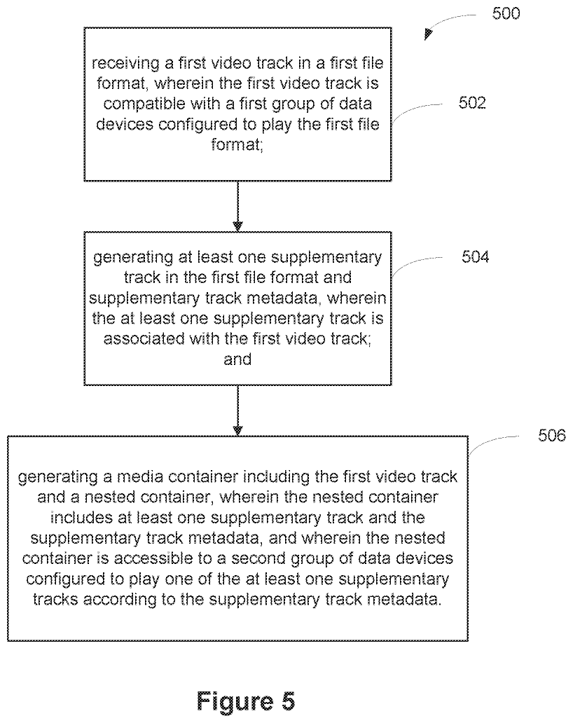

FIG. 5 is a flowchart 500 of an example method for implementing a media container file format configured for depth, editing and machine learning in accordance with one or more of the examples disclosed.

The example method for implementing a media container file format as described in flowchart 500 may be implemented according to coded logic stored in the storage device 208 and executed by the processor 206. In some examples, the results of this method may be presented in the user interface 204 portion of the computing device 200. The boxes of the flowchart correspond to individual steps and/or elements of one example method for providing a media container as described in the provided examples.

At block 502, the method shown in flowchart 500 begins with, receiving a first video track in a first file format, wherein the first video track is compatible with a first group of data devices configured to play the first file format.

At block 504, the method continues by generating at least one supplementary track in the first file format and supplementary track metadata, wherein the at least one supplementary track is associated with the first video track.

At block 506, the method continues by generating a media container including the first video track and a nested container, wherein the nested container includes the at least one supplementary track and the supplementary track metadata, and wherein the nested container is accessible to a second group of data devices configured to play one of the at least one supplementary tracks according to the supplementary track metadata.

In some examples, the method includes that the first file format is selected from the consisting of: an ISO base media file format (ISOBMFF) or an MPEG-4 (MP4) format.

In some examples, the method includes that the first group of data devices includes at least one video recording device.

In some examples, the method includes the second group of data devices includes at least one video editing application.

In some examples, the method includes that the first group of data devices are legacy data devices.

In some examples, the media container may include at least one synthetically generated video track.

In some examples, the method specifies that the nested container includes metadata specifying a file offset and a file length associated with an enhanced descriptor for visual and depth data (edvd) box.

In some examples, the method wherein the edvd box includes a depth source file having a sharp video track and a depth map track.

In some examples, the method wherein the depth source file includes a timed metadata track associated with the second video track.

In some examples, the method wherein the timed metadata track is aligned with timestamps associated with the sharp video track and the depth map track.

In some examples, the method wherein generating the media container further includes generating a composite video track based on the second video track and the at least one supplementary track.

In some examples, the method further includes generating depth metadata associated with the first video track, wherein the depth metadata is accessible by the second group of data devices.

In some examples, the method further includes rendering a bokeh video track associated with the first video track, wherein the bokeh video track is accessible by the second group of data devices.

In some examples, the method wherein the at least one supplementary track includes segmentation information.

In some examples, the method, wherein the segmentation information is determined according to a translucent track encoded as a grayscale.

In some examples, the method wherein the at least one supplementary track includes a first camera view and a second camera view configured for use in an augmented reality model.

In some examples, the method wherein the first camera view includes a first focus, and wherein the second camera view includes a second camera focus.

The present disclosure is not to be limited in terms of the particular examples described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative examples described in the detailed description, figures, and claims are not meant to be limiting. Other examples and configurations can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with the disclosed examples. Alternative examples are included within the scope of the provided disclosure. In some examples, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and examples have been described herein, other aspects and examples will be apparent to those skilled in the art. The various aspects and examples disclosed herein are provided for explanatory purposes and are not intended to be limiting, with the true scope being indicated by the following claims.

What is claimed is:

1. A method comprising:
receiving a first video track in a first file format, wherein the first video track is compatible with a first group of data devices configured to play the first file format;
generating at least one supplementary track in the first file format and supplementary track metadata, wherein the at least one supplementary track is associated with the first video track; and
generating a media container including the first video track and a nested container, wherein the nested container includes the at least one supplementary track and the supplementary track metadata, and wherein the nested container is accessible to a second group of data devices configured to play one of the at least one supplementary tracks according to the supplementary track metadata.

2. The method of claim 1, wherein the first file format is selected from the consisting of: an ISO base media file format (ISOBMFF) or an MPEG-4 (mp4) format.

3. The method of claim 1, wherein the first group of data devices includes at least one video recording device.

4. The method of claim 3, wherein the second group of data devices includes at least one video editing application.

5. The method of claim 1, wherein the first group of data devices are legacy data devices.

6. The method of claim 1, wherein the nested container includes metadata specifying a file offset and a file length associated with an enhanced descriptor for visual and depth data (edvd) box.

7. The method of claim 6, wherein the edvd box includes a depth source file having a sharp video track and a depth map track.

8. The method of claim 7, wherein the depth source file includes a timed metadata track associated with the second video track.

9. The method of claim 8, wherein the timed metadata track is aligned with timestamps associated with the sharp video track and the depth map track.

10. The method of claim 1, wherein generating the media container further includes:
generating a composite video track based on the second video track and the at least one supplementary track.

11. The method of claim 1, further comprising:
generating depth metadata associated with the first video track, wherein the depth metadata is accessible by the second group of data devices.

12. The method of claim 11, further comprising:
rendering a bokeh video track associated with the first video track, wherein the bokeh video track is accessible by the second group of data devices.

13. The method of claim 1, wherein the at least one supplementary track includes segmentation information.

14. The method of claim 13, wherein the segmentation information is determined according to a translucent track encoded as a grayscale.

15. The method of claim 1, wherein the at least one supplementary track includes a first camera view and a second camera view configured for use in an augmented reality model.

16. The method of claim 15, wherein the first camera view includes a first focus, and wherein the second camera view includes a second camera focus.

17. A video capturing device comprising one or more processors and one or more non-transitory computer readable media storing program instructions executable by the one or more processors to perform operations comprising:
receiving a first video track in a first file format, wherein the first video track is compatible with a first group of data devices configured to play the first file format;
generating at least one supplementary track in the first file format and supplementary track metadata, wherein the at least one supplementary track is associated with the first video track; and
generating a media container including the first video track and a nested container, wherein the nested container includes the at least one supplementary track and the supplementary track metadata, and wherein the nested container is accessible to a second group of data devices configured to play one of the at least one supplementary tracks according to the supplementary track metadata.

18. One or more non-transitory computer readable media storing program instructions executable by one or more processors to perform operations comprising:
receiving a first video track in a first file format, wherein the first video track is compatible with a first group of data devices configured to play the first file format;
generating at least one supplementary track in the first file format and supplementary track metadata, wherein the at least one supplementary track is associated with the first video track; and
generating a media container including the first video track and a nested container, wherein the nested container includes the at least one supplementary track and the supplementary track metadata, and wherein the nested container is accessible to a second group of data devices configured to play one of the at least one supplementary tracks according to the supplementary track metadata.
